(19) United States
(12) Patent Application Publication
(10) Pub. No.: US 2025/0125891 A1
(43) Pub. Date: Apr. 17, 2025

(54) MEASUREMENTS FOR RECEIVED SIGNAL STRENGTH INDICATOR DETERMINATION DURING A FRAME BASED EQUIPMENT IDLE PERIOD

(71) Applicant: QUALCOMM Incorporated, San Diego, CA (US)

(72) Inventors: Shaozhen GUO, Beijing (CN); Jing SUN, San Diego, CA (US); Ozcan OZTURK, San Diego, CA (US); Xiaoxia ZHANG, San Diego, CA (US); Changlong XU, Beijing (CN)

(21) Appl. No.: 18/694,679

(22) PCT Filed: Nov. 30, 2021
(86) PCT No.: PCT/CN2021/134380

§ 371 Date: Mar. 22, 2024

(51) Int. Cl. H04B 17/318; H04W 88/02

(52) U.S. Cl. CPC H04B 17/318; H04W 88/02

(57) ABSTRACT

Various aspects of the present disclosure generally relate to wireless communication. In some aspects, a user equipment (UE) may perform, in an occasion during an idle period associated with a frame based equipment (FBE) mode, measurements to determine a received signal strength indicator (RSSI). Accordingly, the UE may transmit, to a base station, a report based at least in part on the RSSI. In other aspects, a UE may perform, during an idle period associated with an FBE mode, measurements on a sidelink channel. Accordingly, the UE may determine a sidelink RSSI (SL RSSI) using the measurements. Numerous other aspects are described.

### FIELD OF THE DISCLOSURE

Aspects of the present disclosure generally relate to wireless communication and to techniques and apparatuses for configuring and performing measurements for received signal strength indicator determination during a frame based equipment idle period.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include performing, in an occasion during an idle period associated with a frame based equipment (FBE) mode, measurements to determine a received signal strength indicator (RSSI). The method may include transmitting, to a base station, a report based at least in part on the RSSI.

Some aspects described herein relate to an apparatus for wireless communication at a UE. The apparatus may include a memory and one or more processors coupled to the memory. The memory may include instructions executable by the one or more processors to cause the UE to perform, in an occasion during an idle period associated with an FBE mode, measurements to determine an RSSI. The memory may further include instructions executable by the one or more processors to cause the UE to transmit, to a base station, a report based at least in part on the RSSI.

Some aspects described herein relate to a non-transitory computer-readable medium that stores a set of instructions for wireless communication by a UE. The set of instructions, when executed by one or more processors of the UE, may cause the UE to perform, in an occasion during an idle period associated with an FBE mode, measurements to determine an RSSI. The set of instructions, when executed by one or more processors of the UE, may further cause the UE to transmit, to a base station, a report based at least in part on the RSSI.

Some aspects described herein relate to an apparatus for wireless communication. The apparatus may include means for performing, in an occasion during an idle period associated with an FBE mode, measurements to determine an RSSI. The apparatus may further include means for transmitting, to a base station, a report based at least in part on the RSSI.

Some aspects described herein relate to a method of wireless communication performed by a base station. The method may include transmitting, to a UE, an indication of an RSSI measurement timing configuration (RMTC) associated with an idle period of an FBE mode. The method may include receiving, from the UE, a report based at least in part on the indication of the RMTC.

Some aspects described herein relate to an apparatus for wireless communication at a base station. The apparatus may include a memory and one or more processors coupled to the memory. The memory may include instructions executable by the one or more processors to cause the base station to transmit, to a UE, an indication of an RMTC associated with an idle period of an FBE mode. The memory may further include instructions executable by the one or more processors to cause the base station to receive, from the UE, a report based at least in part on the indication of the RMTC.

Some aspects described herein relate to a non-transitory computer-readable medium that stores a set of instructions for wireless communication by a base station. The set of instructions, when executed by one or more processors of the base station, may cause the base station to transmit, to a UE, an indication of an RMTC associated with an idle period of an FBE mode. The set of instructions, when executed by one or more processors of the base station, may further cause the base station to receive, from the UE, a report based at least in part on the indication of the RMTC.

Some aspects described herein relate to an apparatus for wireless communication. The apparatus may include means for transmitting, to a UE, an indication of an RMTC associated with an idle period of an FBE mode. The apparatus may further include means for receiving, from the UE, a report based at least in part on the indication of the RMTC.

Some aspects described herein relate to a method of wireless communication performed by a UE. The method may include performing, during an idle period associated with an FBE mode, measurements on a sidelink channel. The method may include determining a sidelink received signal strength indicator (SL RSSI) using the measurements.

Some aspects described herein relate to an apparatus for wireless communication at a UE. The apparatus may include a memory and one or more processors coupled to the memory. The memory may include instructions executable by the one or more processors to cause the UE to perform, during an idle period associated with an FBE mode, measurements on a sidelink channel. The memory may further include instructions executable by the one or more processors to cause the UE to determine an SL RSSI using the measurements.

Some aspects described herein relate to a non-transitory computer-readable medium that stores a set of instructions for wireless communication by a UE. The set of instructions, when executed by one or more processors of the UE, may cause the UE to perform, during an idle period associated with an FBE mode, measurements on a sidelink channel. The set of instructions, when executed by one or more processors of the UE, may further cause the UE to determine an SL RSSI using the measurements.

Some aspects described herein relate to an apparatus for wireless communication. The apparatus may include means for performing, during an idle period associated with an FBE mode, measurements on a sidelink channel. The apparatus may further include means for determining an SL RSSI using the measurements.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a frame based equipment (FBE) idle period, in accordance with the present disclosure.

FIG. 4 is a diagram illustrating an example associated with configuring and performing measurements for received signal strength indicator (RSSI) determination during an FBE idle period, in accordance with the present disclosure.

FIG. 5 is a diagram illustrating an example associated with performing measurements for sidelink RSSI determination during an FBE idle period, in accordance with the present disclosure.

FIGS. 6A, 6B, and 6C are diagrams illustrating examples associated with an RSSI measurement timing configuration (RMTC), in accordance with the present disclosure.

FIG. 7 is a diagram illustrating an example associated with RSSI reporting associated with an FBE idle period, in accordance with the present disclosure.

FIGS. 8 and 9 are diagrams illustrating example processes associated with configuring and performing measurements for RSSI determination during an FBE idle period, in accordance with the present disclosure.

FIG. 10 is a diagram illustrating an example process associated with performing measurements for sidelink RSSI determination during an FBE idle period, in accordance with the present disclosure.

FIGS. 11 and 12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

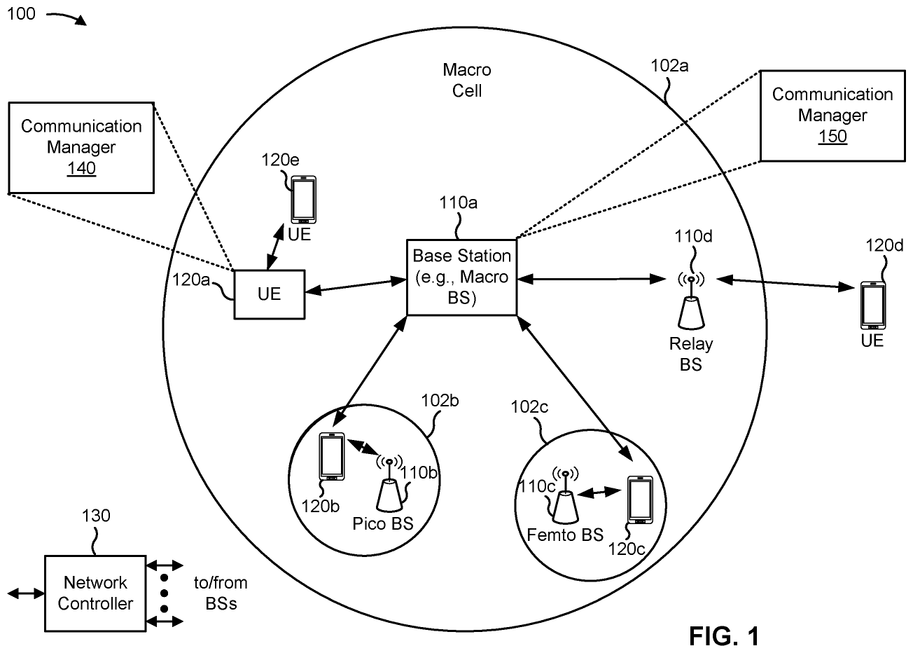

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform, in an occasion during an idle period associated with a frame based equipment (FBE) mode, measurements to determine a received signal strength indicator (RSSI), and transmit (e.g., to the base station 110) a report based at least in part on the RSSI. Additionally, or alternatively, and as described in more detail elsewhere herein, the communication manager 140 may perform, during an idle period associated with an FBE mode, measurements on a sidelink channel, and determine a sidelink RSSI (SL RSSI) using the measurements. Additionally, or alternatively, the communication manager 140 may perform one or more other operations described herein.

In some aspects, the base station 110 may include a communication manager 150. As described in more detail elsewhere herein, the communication manager 150 may transmit (e.g., to the UE 120) an indication of an RSSI measurement timing configuration (RMTC) associated with an idle period of an FBE mode and receive (e.g., from the UE 120) a report based at least in part on the indication of the RMTC. Additionally, or alternatively, the communication manager 150 may perform one or more other operations described herein.

As indicated above, FIG. 1 is provided as an example. Other examples may differ from what is described with regard to FIG. 1.

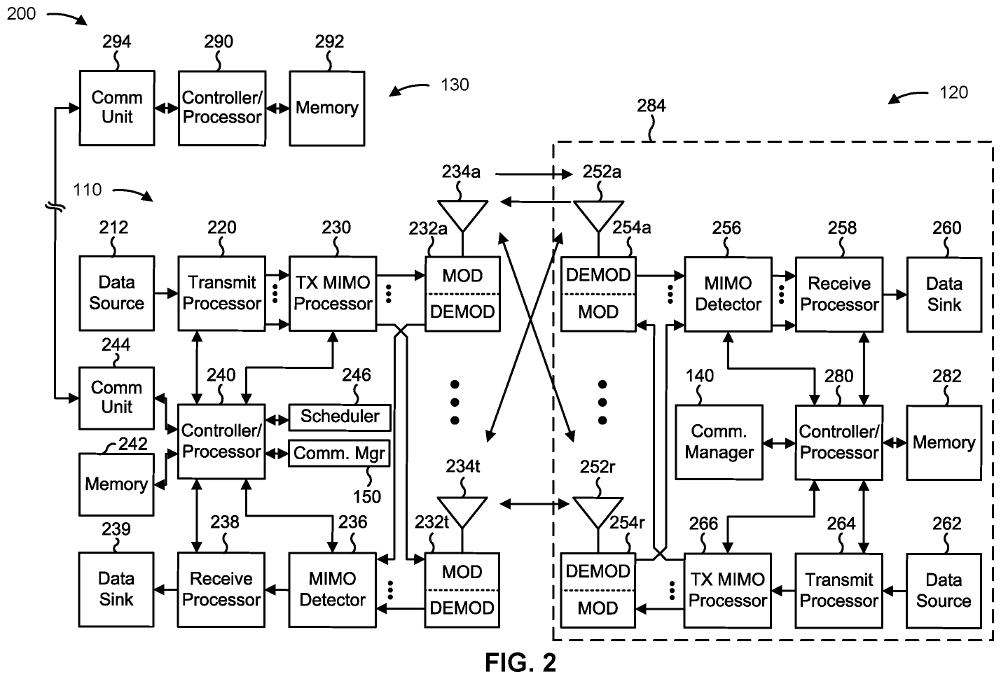

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

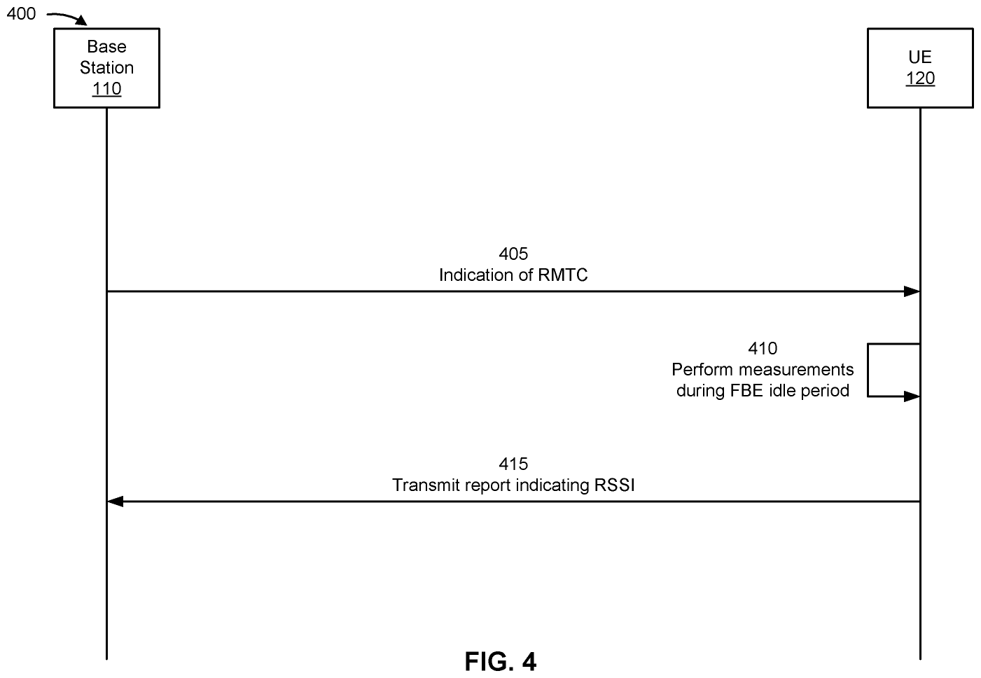

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

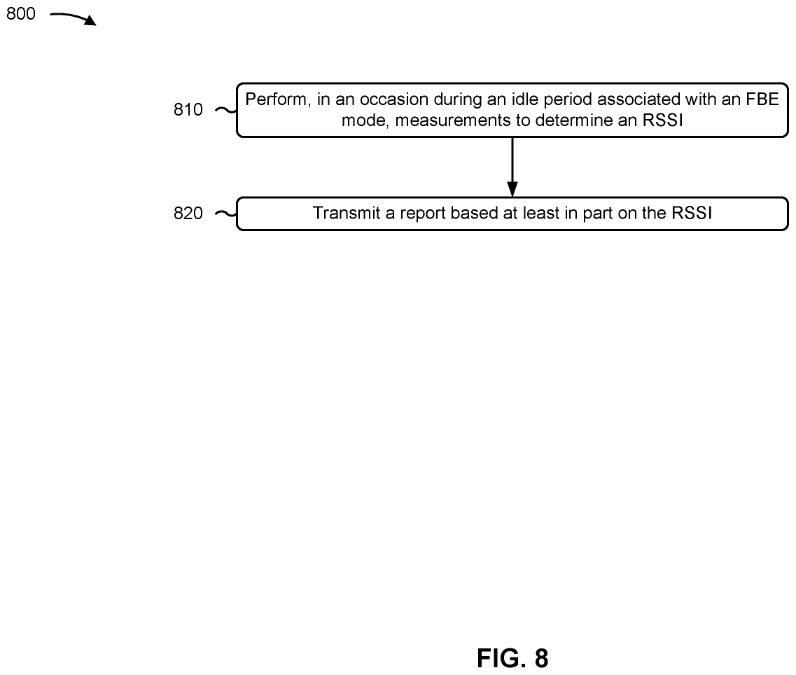

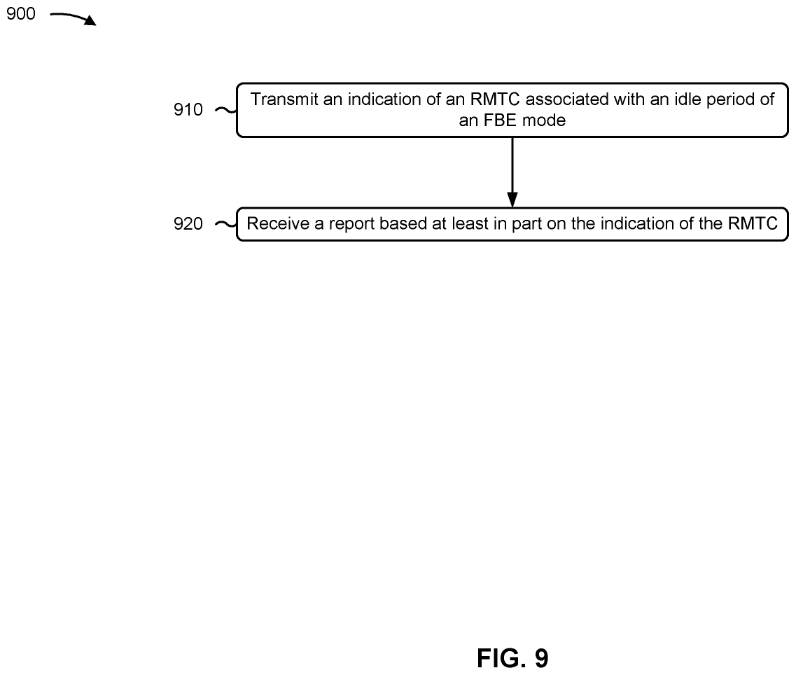

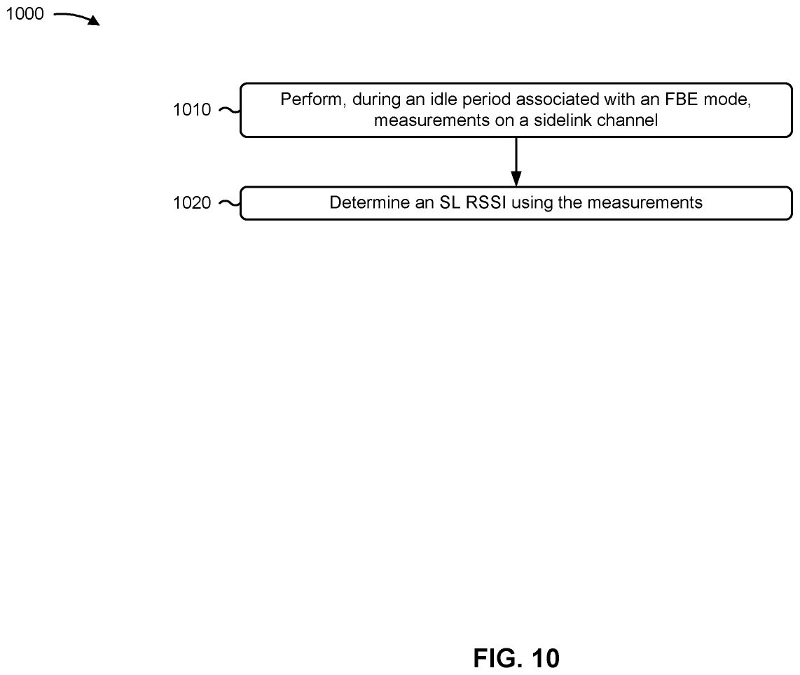

The controller/processor 240 of the base station 110, the controller/processor 280 of the UE 120, and/or any other component(s) of FIG. 2 may perform one or more techniques associated with configuring and performing measurements for RSSI determination during an FBE idle period, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

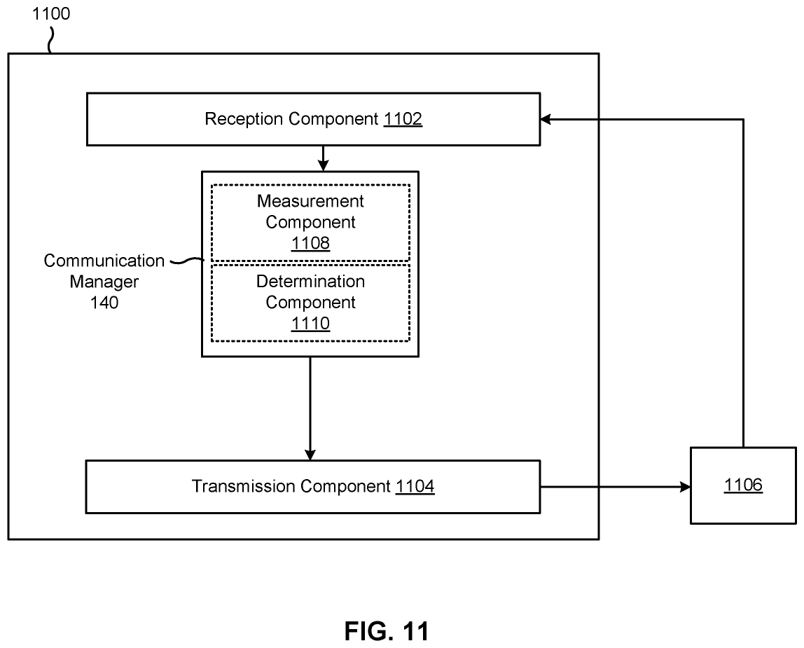

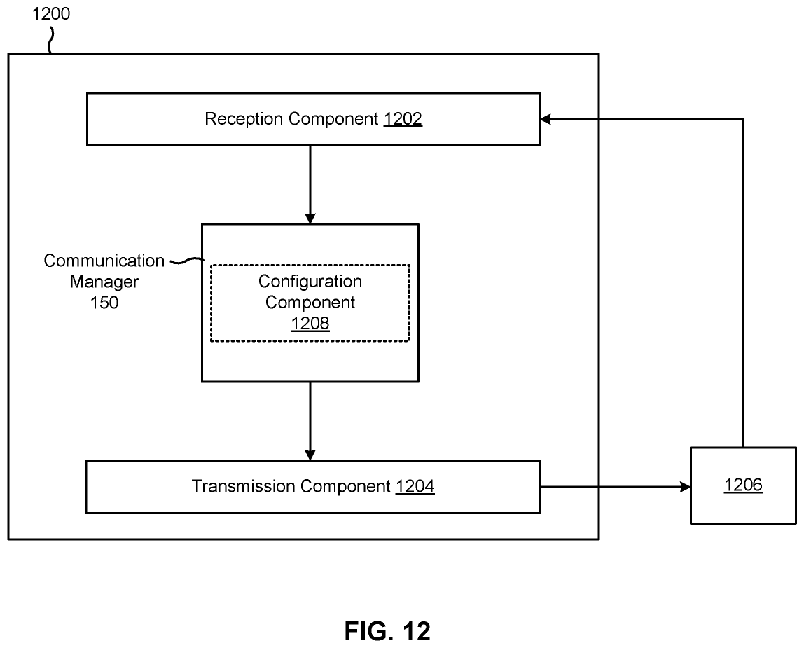

In some aspects, a UE (e.g., the UE 120 and/or apparatus 1100 of FIG. 11) may include means for performing, in an occasion during an idle period associated with an FBE mode, measurements to determine an RSSI; and/or means for transmitting, to a base station (e.g., the base station 110 and/or apparatus 1200 of FIG. 12), a report based at least in part on the RSSI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282. Additionally, or alternatively, the UE may include means for performing, during an idle period associated with an FBE mode, measurements on a sidelink channel; and/or means for determining an SL RSSI using the measurements.

In some aspects, a base station (e.g., the base station 110 and/or apparatus 1200 of FIG. 12) may include means for transmitting, to a UE (e.g., the UE 120 and/or apparatus 1100 of FIG. 11), an indication of an RMTC associated with an idle period of an FBE mode; and/or means for receiving, from the UE, a report based at least in part on the indication of the RMTC. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

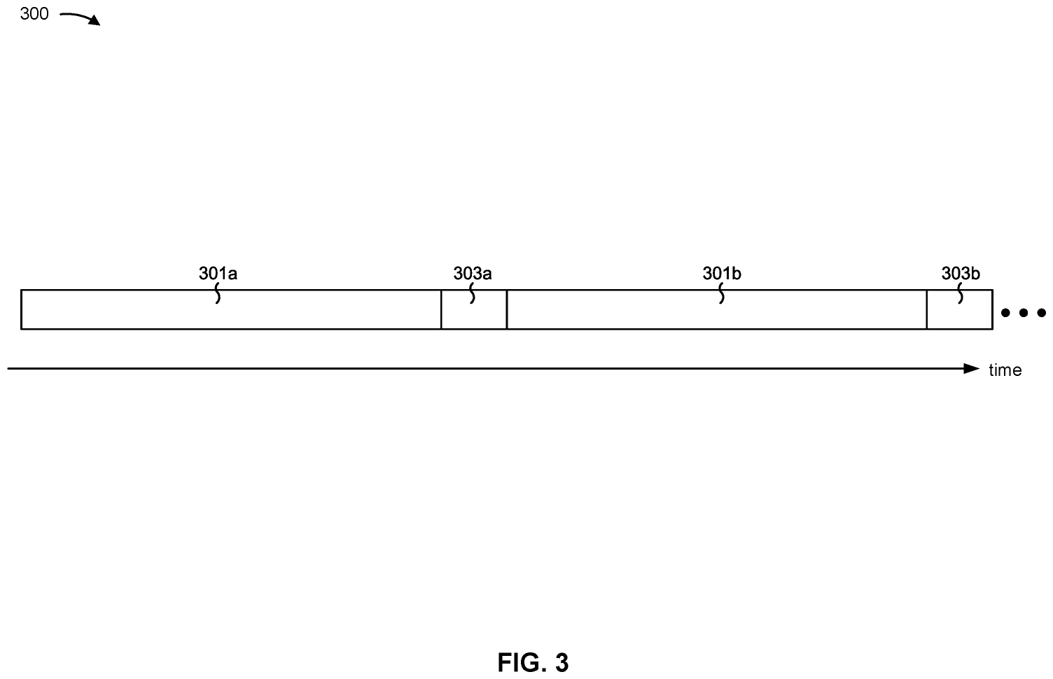

FIG. 3 is a diagram illustrating an example 300 of an FBE idle period, in accordance with the present disclosure. “FBE” may refer to a listen before talk (LBT) mode in which a UE (e.g., UE 120) performs channel sensing (e.g., using clear channel assessment (CCA) and/or another similar type of technique) at fixed time periods, as configured by the network (e.g., via base station 110) and/or programmed (or otherwise preconfigured) into the UE 120 (e.g., according to 3GPP specifications). FBE may allow for the UE 120 to experience increased throughput by using an unlicensed band (e.g., a 5 GHz band) in addition to a licensed band.

As shown in FIG. 3, in FBE mode, the UE 120 may transmit to, and receive from, the base station 110 during a channel occupancy time (COT) 301 and may not transmit or receive during an idle period 303. Together, the COT 301 and the idle period 303 are referred to as a “fixed frame period” or “FFP.” As further shown in FIG. 3, the FFP may be periodic (e.g., the COT repeats in time, shown as COTs 301a, 301b, and so on, and the idle period repeats in time, shown as idle periods 303a, 303b, and so on). Accordingly, the UE 120 performs channel sensing when an idle period ends and a corresponding COT begins.

Although the FBE mode described with respect to FIG. 3 is in connection with the base station 110, the UE 120 may similarly use an FBE mode when communicating on a sidelink channel (e.g., with another UE).

Generally, a starting radio frame for each FFP is determined according to 3GPP specifications (e.g., starting offset from a radio frame associated with an even frame number and offset according to i*P, where P represents the period associated with the FFP, and i represents an integer from 0 to 20/(P−1). Additionally, the idle period for each FFP is generally at least 100 microseconds (μs) or 5% of the FFP, whichever is longer.

In FBE mode, a UE may be configured to perform measurements. For example, a base station may configure the UE to perform and report layer 3 (L3) measurements, such as RSSI, periodically. When performing RSSI measurements, the UE cannot transmit or receive, which increases latency. Generally, the base station configures the UE to perform measurements at a beginning of a subframe, which is during the COT in FBE mode.

Some techniques and apparatuses described herein enable a UE (e.g., UE 120) to perform measurements to determine RSSI during an idle period associated with an FBE mode. For example, a base station (e.g., base station 110) may use an RMTC configuration to align measurement occasions with the idle period. Additionally, or alternatively, the UE 120 may perform measurements to determine SL RSSI during the idle period. As a result, the UE 120 experiences improved latency and throughput because less of a corresponding COT is used to perform L3 measurements.

As indicated above, FIG. 3 is provided as an example. Other examples may differ from what is described with respect to FIG. 3.

FIG. 4 is a diagram illustrating an example 400 associated with configuring and performing measurements for RSSI determination during an FBE idle period, in accordance with the present disclosure. As shown in FIG. 4, a base station 110 and a UE 120 may communicate with one another.

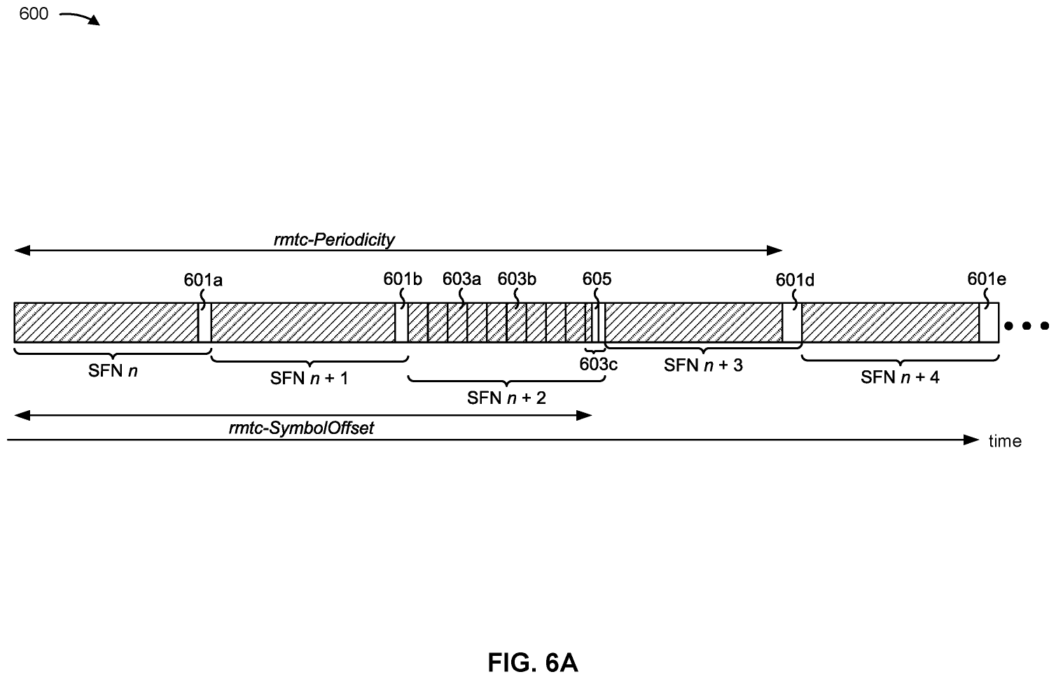

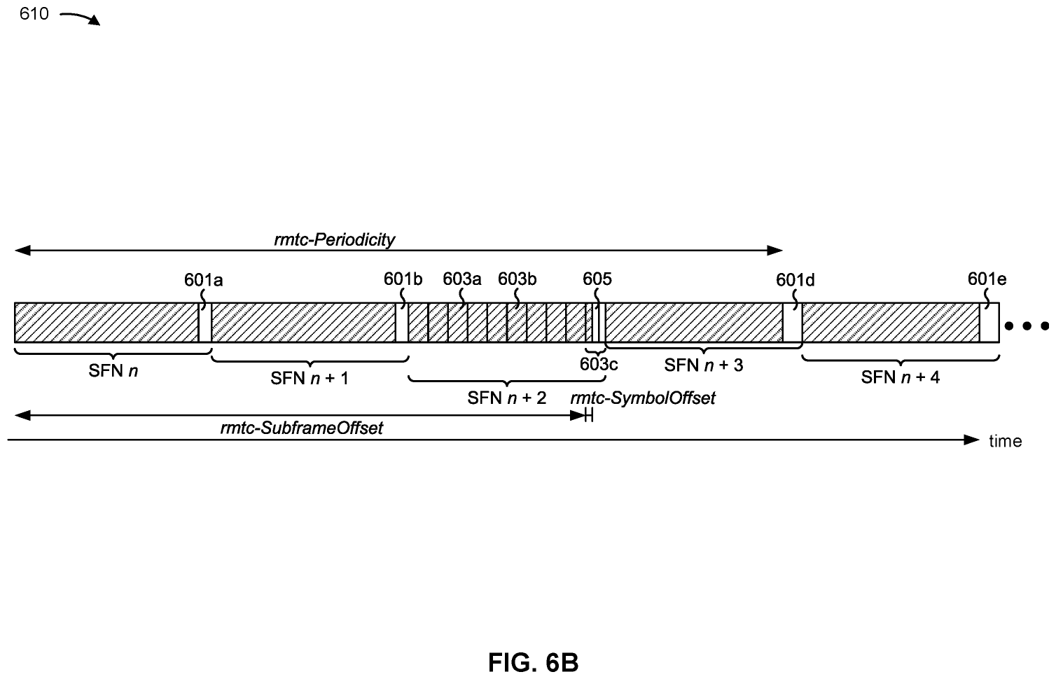

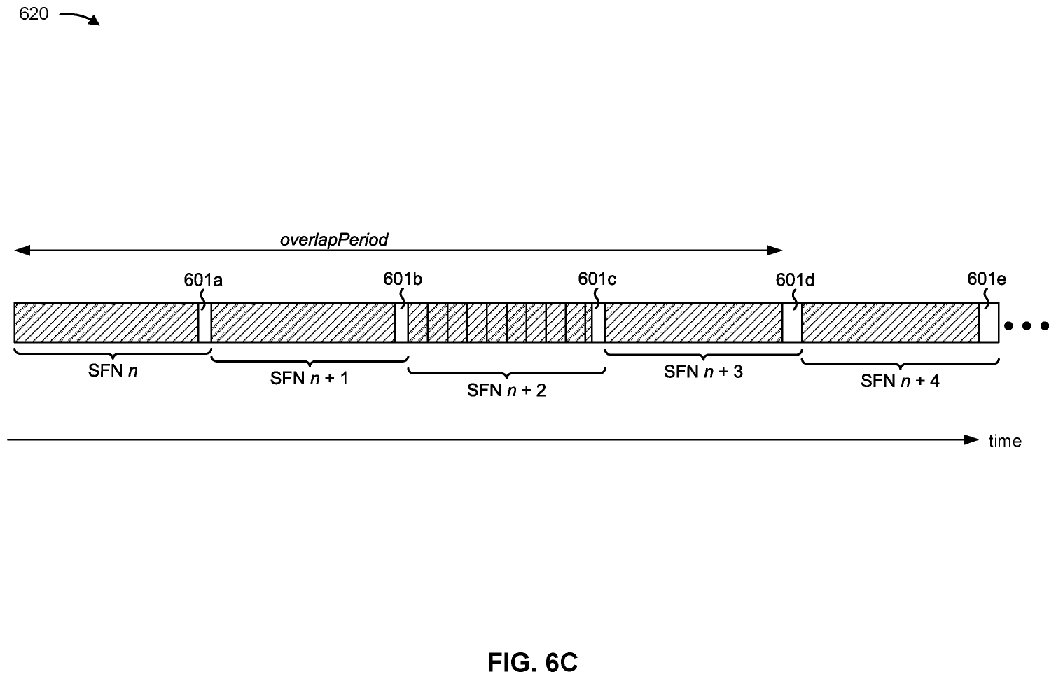

As shown by reference number 405, the base station 110 may transmit, and the UE 120 may receive, an indication of an RMTC. The RMTC may be associated with an idle period of an FBE mode (e.g., as described in connection with FIG. 3). The RMTC may align measurement occasions with the idle period, as described in connection with FIGS. 6A, 6B, and 6C.

Accordingly, as shown by reference number 410, the UE 120 may perform measurements to determine an RSSI during the idle period associated with the FBE mode. As the base station 110 and UE 120 shall not transmit anything during the idle period associated with FBE mode, the UE 120 can perform measurements on one or more other RATs (such as on reference signals from one or more neighboring cells and/or on reference signals from one or more frequencies not used between the base station 110 and the UE 120) during the idle period. Accordingly, the UE 120 may calculate the RSSI using measurements during the idle period associated with FBE mode.

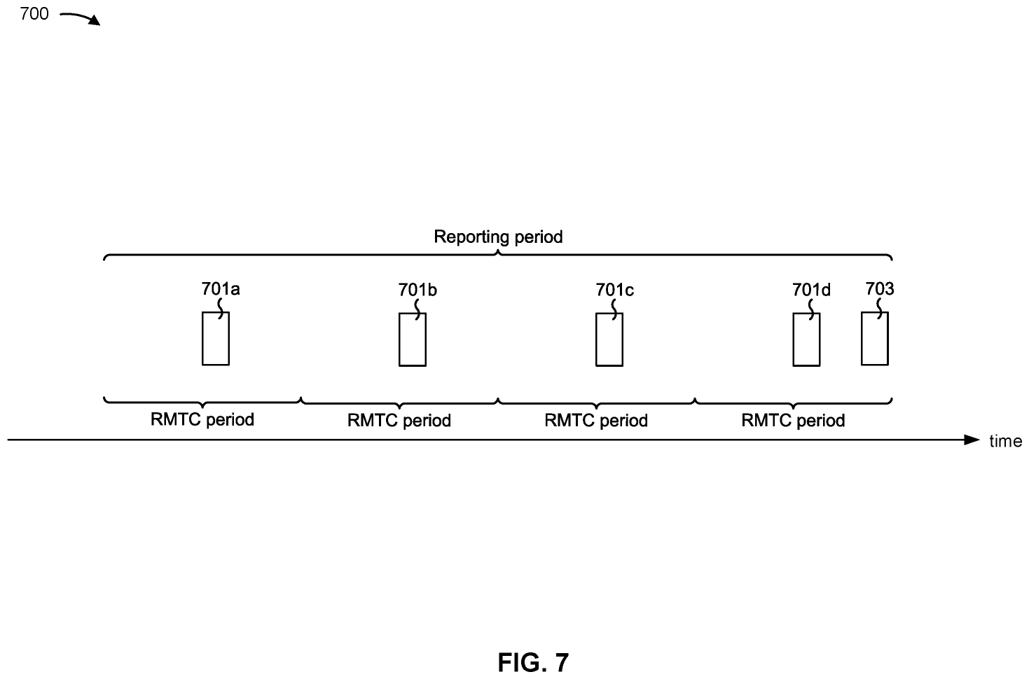

As shown by reference number 415, the UE 120 may transmit, and the base station 110 may receive, a report based at least in part on the RSSI. For example, the UE 120 may transmit a CSI report and/or another type of report. Although shown as associated with a single measurement occasion for determining RSSI, in some aspects, the report may be associated with a measurement reporting occasion and a plurality of measurement occasions. Accordingly, as described in connection with FIG. 7, the report may indicate a maximum of a plurality of RSSIs, a minimum of a plurality of RSSIs, an average (e.g., a linear average) of a plurality of RSSIs, and/or another combination of a plurality of RSSIs.

By using techniques as described in connection with FIG. 4, the UE 120 performs measurements to determine RSSI during the idle period associated with the FBE mode. As a result, the UE 120 experiences improved latency and throughput because less of a corresponding COT is used to perform L3 measurements.

As indicated above, FIG. 4 is provided as an example. Other examples may differ from what is described with respect to FIG. 4.

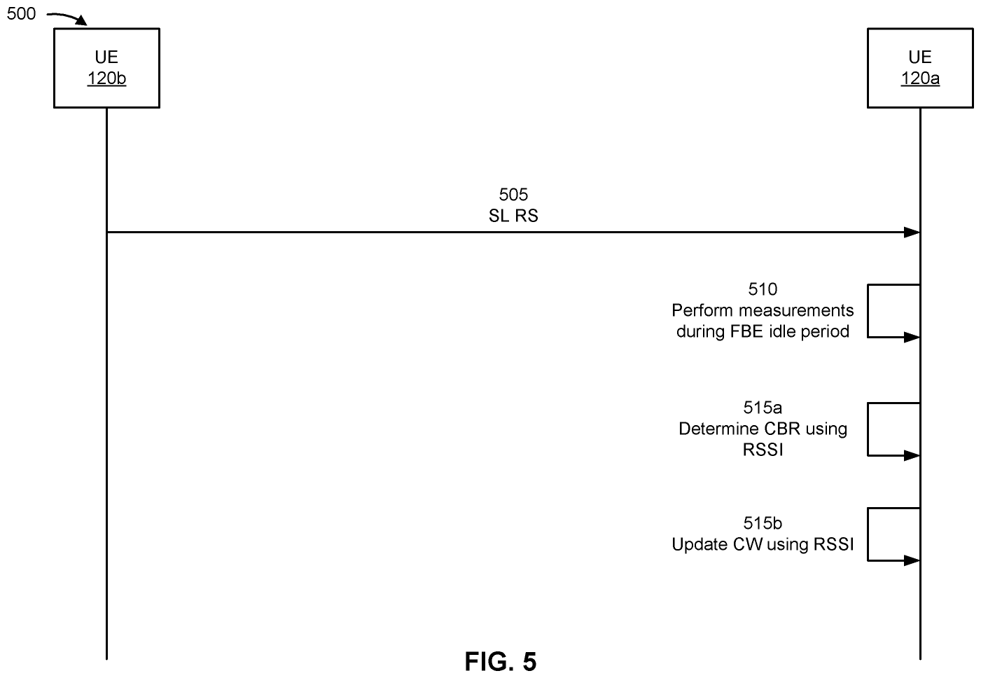

FIG. 5 is a diagram illustrating an example 500 associated with performing measurements for SL RSSI determination during an FBE idle period, in accordance with the present disclosure. As shown in FIG. 4, a UE 120a and a UE 120b may communicate with one another on a sidelink channel.

In example 500, the UE 120a and the UE 120b are preconfigured (e.g., programmed) to use an FBE mode on the sidelink channel. For example, the UE 120a and the UE 120b may use an FBE mode with default settings (e.g., from 3GPP specifications) rather than settings indicated in an RMTC indication from a network (e.g., from a base station, such as base station 110).

As shown by reference number 505, the UE 120b may transmit, and the UE 120a may receive, a sidelink reference signal (SL RS). For example, the SL RS may include a sidelink synchronization signal (SLSS) and/or another type of reference signal used on sidelink channels.

Accordingly, as shown by reference number 510, the UE 120a may perform measurements to determine an RSSI during the idle period associated with the FBE mode. The UE 120a may calculate the SL RSSI using measurements of the SL RS.

As shown by reference number 515a, the UE 120a may determine a channel busy ratio (CBR) based at least in part on the SL RSSI. For example, the UE 120a may calculate the CBR as a ratio of occupied subchannels within a preceding 100 slots, where a subchannel is classified as “occupied” when the SL RSSI exceeds a threshold (e.g., programmed, or otherwise preconfigured, into the UE 120a according to 3GPP specifications). As used herein, “subchannel” refers to a group of resource blocks (RBs) within a larger bandwidth that is used on a sidelink channel. Also, as used herein, “slot” refers to a portion of a radio frame (or part of a frame, such as a subframe) within an LTE, 5G, or other wireless communication structure. In some aspects, a slot may include one or more symbols, where “symbol” may refer to an OFDM symbol or other similar symbol within a slot.

By using SL RSSI determined using measurements during the idle period, the UE 120a may determine a more accurate CBR. Because CBR is used to determine a transmission rate, a transmit power, an MCS, and/or other transmission parameters used on the sidelink channel, a more accurate CBR leads to increased throughput (e.g., when channel conditions are better) or increased quality and reliability (e.g., when channel conditions are worse).

Additionally, or alternatively, and as shown by reference number 515b, the UE 120a may update a contention window (CW) associated with the sidelink channel based at least in part on the SL RSSI. For example, when the SL RSSI satisfies a threshold (e.g., programmed, or otherwise preconfigured, into the UE 120a according to 3GPP specifications), the UE 120a may set the CW to a minimum value in order to decrease latency. Otherwise, the UE 120a may increment the CW to a next higher allowed value. The UE 120a may continue to increment the CW as long as the SL RSSI fails to satisfy the threshold. Accordingly, the UE 120a may incrementally increase quality and reliability on the sidelink channel (which conserves power and processing resources by reducing required retransmissions) as long as the SL RSSI fails to satisfy the threshold.

By using techniques as described in connection with FIG. 5, the UE 120a performs measurements to determine SL RSSI during the idle period. As a result, the UE 120a experiences improved latency and throughput because less of a corresponding COT is used to perform L3 measurements.

As indicated above, FIG. 5 is provided as an example. Other examples may differ from what is described with respect to FIG. 5.

FIG. 6A is a diagram illustrating an example 600 associated with an RMTC, in accordance with the present disclosure. As shown in FIG. 6A, example 600 includes system frame numbers (SFNs) n through n+4, where each SFN includes at least one FFP (e.g., as described in connection with FIG. 3). Accordingly, each SFN includes at least one idle period 601 (e.g., shown as idle periods 601a, 601b, 601d, 601e, and so on; idle period 601c would be included in SFN n+2 but is not labeled in order to reduce clutter). An SFN includes a plurality of subframes (e.g., 10 subframes in example 600). Subframes 603a, 603b, and 603c are labeled, as examples.

An RMTC is associated with a periodicity (e.g., parameter rmtc-Periodicity, as defined in 3GPP specifications, included in an indication of the RMTC from a base station, such as base station 110). Accordingly, in example 600, a UE (e.g., UE 120) is to perform measurements to determine RSSI every four SFNs. Additionally, a measurement occasion for the UE 120 to use is determined according to an offset from an initial SFN (e.g., SFN n in example 600). The initial SFN may be determined according to rules applied to the offset (e.g., as defined in 3GPP specifications).

Because the idle period does not generally align with a beginning of a subframe (as shown in FIG. 6A), the base station 110 may indicate a symbol-level offset for determining the measurement occasion (e.g., using a new rmtc-SymbolOffset parameter, as shown in FIG. 6A). As a result, measurement occasion 605 may be configured within an idle period by using the symbol-level offset in lieu of a subframe-level offset. Additionally, because the symbol-level offset replaces a subframe-level offset, the base station 110 may use a same number of parameters for indicating an RMTC associated with an FBE mode as for indicating an RMTC not associated with an FBE mode.

The symbol-level offset may be based at least in part on a subcarrier spacing (SCS) used by the base station 110 (e.g., indicated in a ref-SCS-CP parameter, as defined in 3GPP specifications). For example, the symbol-level offset may range from 0 symbols to 8959 symbols for an SCS of 15 kHz, from 0 symbols to 17919 symbols for an SCS of 30 kHz, from 0 symbols to 35839 symbols for 60 kHz with a normal cyclic prefix (NCP), and from 0 symbols to 30719 symbols for 60 kHz with an extended cyclic prefix (ECP).

FIG. 6B is a diagram illustrating an example 610 associated with an RMTC, in accordance with the present disclosure. Example 610 of FIG. 6B is similar to example 600 of FIG. 6A except that, in example 610, the base station 110 may indicate a symbol-level offset for determining the measurement occasion in addition to a subframe-level offset (e.g., using parameter rmtc-SubframeOffset, as defined in 3GPP specifications). As a result, measurement occasion 605 may be configured within an idle period by using a combination of the symbol-level offset and the subframe-level offset.

The symbol-level offset may be based at least in part on an SCS used by the base station 110 (e.g., indicated in a ref-SCS-CP parameter, as defined in 3GPP specifications). For example, the symbol-level offset may range from 0 symbols to 13 symbols for an SCS of 15 kHz, from 0 symbols to 27 symbols for an SCS of 30 kHz, from 0 symbols to 55 symbols for 60 kHz with an NCP, and from 0 symbols to 47 symbols for 60 kHz with an ECP. Accordingly, using the subframe-level offset in combination with the symbol-level offset reduces a quantity of bits needed for the symbol-level offset.

In examples 600 and 610, the base station 110 may further indicate a measurement duration longer than one symbol and shorter than one slot (e.g., using a measDurationSymbols parameter, as defined in 3GPP specifications). For example, the base station 110 may configure a measurement duration of 2 symbols, 3 symbols, 4 symbols, 5 symbols, 6 symbols, 7 symbols, 8 symbols, 9 symbols, 10 symbols, 11 symbols, 12 symbols, or 13 symbols.

As an alternative, and as shown in FIG. 6C, the base station 110 may configure the measurement period to overlap with an idle period rather than for a fixed quantity of symbols that are aligned within the idle period using an offset. Similar to example 600, example 620 includes SFNs n through n+4, where each SFN includes at least one FFP (e.g., as described in connection with FIG. 3). Accordingly, each SFN includes at least one idle period 601 (e.g., shown as idle periods 601a, 601b, 601c, 601d, 601e, and so on).

An RMTC is associated with a periodicity (e.g., parameter rmtc-Periodicity, as defined in 3GPP specifications, included in an indication of the RMTC from a base station, such as base station 110). Accordingly, in example 600, a UE (e.g., UE 120) is to perform measurements to determine RSSI every four SFNs. For example, the base station 110 may use a new RMTC-Config data structure that includes an overlapPeriod parameter, as shown in FIG. 6C. The overlapPeriod may express the periodicity associated with the RMTC in a quantity of FFPs (e.g., 4, in example 610). Accordingly, the UE 120 performs measurements to determine RSSI once every 4 idle periods.

In some aspects, the UE 120 may perform the measurements in a randomly selected FFP of the quantity of FFPs. As a result, the UE 120 increases accuracy of the RSSIs by avoiding periodic interference.

By using techniques as described in connection with FIGS. 6A, 6B, and 6C, the base station 110 may use an RMTC configuration to align measurement occasions with the idle period. As a result, the UE 120 experiences improved latency and throughput because less of a corresponding COT is used to perform L3 measurements.

As indicated above, FIGS. 6A-6C are provided as examples. Other examples may differ from what is described with respect to FIGS. 6A-6C.

FIG. 7 is a diagram illustrating an example 700 associated with RSSI reporting associated with an FBE idle period, in accordance with the present disclosure. Example 700 shows a plurality of measurement periods, each including a measurement occasion 701 (shown as occasions 701a, 701b, 701c, and 701d in FIG. 7) within a longer reporting period including a measurement reporting occasion 703. Accordingly, a UE (e.g., UE 120) may indicate, in a report transmitted in the measurement reporting occasion 703, a plurality of RSSIs, where each RSSI is associated with a corresponding one of the measurement occasions. Accordingly, a base station (e.g., base station 110) may receive complete information from the UE 120. As an alternative, to conserve network resources and power used to transmit, the UE 120 may indicate, in the report, an average, a median, and/or another combination of the plurality of RSSIs. As an alternative, to conserve processing resources, the UE 120 may indicate, in the report, a minimum or a maximum of the plurality of RSSIs.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120 and/or apparatus 1100 of FIG. 11) performs operations associated with performing measurements for RSSI determination during an FBE idle period.

As shown in FIG. 8, in some aspects, process 800 may include performing, in an occasion during an idle period associated with an FBE mode, measurements to determine an RSSI (block 810). For example, the UE (e.g., using communication manager 140 and/or measurement component 1108, depicted in FIG. 11) may perform, in an occasion during an idle period associated with an FBE mode, measurements to determine an RSSI, as described herein.

As further shown in FIG. 8, in some aspects, process 800 may include transmitting, to a base station (e.g., base station 110 and/or apparatus 1200 of FIG. 12), a report based at least in part on the RSSI (block 820). For example, the UE (e.g., using communication manager 140 and/or transmission component 1104, depicted in FIG. 11) may transmit, to a base station, a report based at least in part on the RSSI, as described herein.

Process 800 may include additional aspects, such as any single aspect or any combination of aspects described below and/or in connection with one or more other processes described elsewhere herein.

In a first aspect, process 800 includes receiving (e.g., using communication manager 140 and/or reception component 1102, depicted in FIG. 11), from the base station, an indication of an RMTC.

In a second aspect, alone or in combination with the first aspect, the indication of the RMTC configuration includes a symbol-level offset associated with an initial SFN.

In a third aspect, alone or in combination with one or more of the first and second aspects, the indication of the RMTC configuration includes a subframe-level offset that is associated with an initial SFN and a symbol-level offset in addition to the subframe-level offset.

In a fourth aspect, alone or in combination with one or more of the first through third aspects, the indication of the RMTC configuration includes a parameter associated with a measurement duration longer than one symbol and shorter than one slot.

In a fifth aspect, alone or in combination with one or more of the first through fourth aspects, the indication of the RMTC configuration includes a periodicity associated with the measurements and expressed in a quantity of FFPs.

In a sixth aspect, alone or in combination with one or more of the first through fifth aspects, the measurements are performed in a randomly selected FFP of the quantity of FFPs.

In a seventh aspect, alone or in combination with one or more of the first through sixth aspects, the report is associated with at least one additional occasion for performing measurements, to determine at least one additional RSSI.

In an eighth aspect, alone or in combination with one or more of the first through seventh aspects, the report further indicates the at least one additional RSSI and each additional RSSI is associated with an additional occasion for performing measurement.

In a ninth aspect, alone or in combination with one or more of the first through eighth aspects, the report indicates a maximum of the RSSI or the at least one additional RSSI.

In a tenth aspect, alone or in combination with one or more of the first through ninth aspects, the report indicates a minimum of the RSSI or the at least one additional RSSI.

In an eleventh aspect, alone or in combination with one or more of the first through tenth aspects, the report indicates an average of the RSSI and the at least one additional RSSI.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110 and/or apparatus 1200 of FIG. 12) performs operations associated with configuring measurements for RSSI determination during an FBE idle period.

As shown in FIG. 9, in some aspects, process 900 may include transmitting, to a UE (e.g., UE 120 and/or apparatus 1100 of FIG. 11), an indication of an RMTC associated with an idle period of an FBE mode (block 910). For example, the base station (e.g., using communication manager 150 and/or transmission component 1204, depicted in FIG. 12) may transmit, to a UE, an indication of an RMTC associated with an idle period of an FBE mode, as described herein.

As further shown in FIG. 9, in some aspects, process 900 may include receiving, from the UE, a report based at least in part on the indication of the RMTC (block 920). For example, the base station (e.g., using communication manager 150 and/or reception component 1202, depicted in FIG. 12) may receive, from the UE, a report based at least in part on the indication of the RMTC, as described herein.

Process 900 may include additional aspects, such as any single aspect or any combination of aspects described below and/or in connection with one or more other processes described elsewhere herein.

In a first aspect, the indication of the RMTC configuration includes a symbol-level offset associated with an initial SFN.

In a second aspect, alone or in combination with the first aspect, the indication of the RMTC configuration includes a subframe-level offset that is associated with an initial SFN and a symbol-level offset in addition to the subframe-level offset.

In a third aspect, alone or in combination with one or more of the first and second aspects, the indication of the RMTC configuration includes a measurement duration longer than one symbol and shorter than one slot.

In a fourth aspect, alone or in combination with one or more of the first through third aspects, the indication of the RMTC configuration includes a periodicity expressed in a quantity of FFPs.

In a fifth aspect, alone or in combination with one or more of the first through fourth aspects, the report is based at least in part on measurements performed in a randomly selected FFP of the quantity of FFPs.

In a sixth aspect, alone or in combination with one or more of the first through fifth aspects, the report indicates an RSSI based at least in part on measurements in an occasion during the idle period.

In a seventh aspect, alone or in combination with one or more of the first through sixth aspects, the report is associated with at least one additional occasion for performing measurements to determine at least one additional RSSI.

In an eighth aspect, alone or in combination with one or more of the first through seventh aspects, the report further indicates the at least one additional RSSI.

In a ninth aspect, alone or in combination with one or more of the first through eighth aspects, the report indicates a maximum of the RSSI or the at least one additional RSSI.

In a tenth aspect, alone or in combination with one or more of the first through ninth aspects, the report indicates a minimum of the RSSI or the at least one additional RSSI.

In an eleventh aspect, alone or in combination with one or more of the first through tenth aspects, the report indicates an average of the RSSI and the at least one additional RSSI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120 and/or apparatus 1100 of FIG. 11) performs operations associated with perform measurements for SL RSSI determination during an FBE idle period.

As shown in FIG. 10, in some aspects, process 1000 may include performing, during an idle period associated with an FBE mode, measurements on a sidelink channel (block 1010). For example, the UE (e.g., using communication manager 140 and/or measurement component 1108, depicted in FIG. 11) may perform, during an idle period associated with an FBE mode, measurements on a sidelink channel, as described herein.

As further shown in FIG. 10, in some aspects, process 1000 may include determining an SL RSSI using the measurements (block 1020). For example, the UE (e.g., using communication manager 140 and/or determination component 1110, depicted in FIG. 11) may determine an SL RSSI using the measurements, as described herein.

Process 1000 may include additional aspects, such as any single aspect or any combination of aspects described below and/or in connection with one or more other processes described elsewhere herein.

In a first aspect, process 1000 further includes determining (e.g., using communication manager 140 and/or measurement component 1108) a CBR based at least in part on the SL RSSI.

In a second aspect, alone or in combination with the first aspect, process 1000 further includes updating (e.g., using communication manager 140 and/or measurement component 1108) a CW associated with the sidelink channel based at least in part on the SL RSSI.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a measurement component 1108 or a determination component 1110, among other examples.

In some aspects, the apparatus 1100 may be configured to perform one or more operations described herein in connection with FIGS. 4-7. Additionally, or alternatively, the apparatus 1100 may be configured to perform one or more processes described herein, such as process 800 of FIG. 8, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

In some aspects, the measurement component 1108 may perform, in an occasion during an idle period associated with an FBE mode, measurements to determine an RSSI. For example, the reception component 1102 may receive, from the apparatus 1106, an indication of an RMTC. Accordingly, the transmission component 1104 may transmit, to the apparatus 1106, a report based at least in part on the RSSI. The measurement component 1108 may include one or more antennas, a modem, a demodulator, a MIMO detector, a receive processor, a controller/processor, a memory, or a combination thereof, of the UE described in connection with FIG. 2.

Additionally, or alternatively, the measurement component 1108 may perform, during an idle period associated with an FBE mode, measurements on a sidelink channel. Accordingly, the determination component 1110 may determine an SL RSSI using the measurements. The determination component 1110 may include a MIMO detector, a receive processor, a transmit MIMO processor, a transmit processor, a controller/processor, a memory, or a combination thereof, of the UE described in connection with FIG. 2.

In some aspects, the determination component 1110 may determine a CBR based at least in part on the SL RSSI. Additionally, or alternatively, the determination component 1110 may update a CW associated with the sidelink channel based at least in part on the SL RSSI.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIGS. 4-7. Additionally, or alternatively, the apparatus 1200 may be configured to perform one or more processes described herein, such as process 900 of FIG. 9, or a combination thereof. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

In some aspects, the transmission component 1204 may transmit, to the apparatus 1206, an indication of an RMTC associated with an idle period of an FBE mode. For example, the configuration component 1208 (which may include a transmit MIMO processor, a transmit processor, a MIMO detector, a receive processor, a controller/processor, a memory, or a combination thereof, of the base station described in connection with FIG. 2) may determine the RMTC for the apparatus 1206 based at least in part on the FBE mode. Accordingly, the reception component 1202 may receive, from the apparatus 1206, a report based at least in part on the indication of the RMTC.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: performing, in an occasion during an idle period associated with a frame based equipment (FBE) mode, measurements to determine a received signal strength indicator (RSSI); and transmitting, to a base station, a report based at least in part on the RSSI.

Aspect 2: The method of Aspect 1, further comprising: receiving, from the base station, an indication of an RSSI measurement timing configuration (RMTC).

Aspect 3: The method of Aspect 2, wherein the indication of the RMTC configuration includes a symbol-level offset associated with an initial system frame number (SFN).

Aspect 4: The method of Aspect 2, wherein the indication of the RMTC configuration includes a subframe-level offset that is associated with an initial system frame number (SFN) and a symbol-level offset in addition to the subframe-level offset.

Aspect 5: The method of any of Aspects 2 through 4, wherein the indication of the RMTC configuration includes a parameter associated with a measurement duration longer than one symbol and shorter than one slot.

Aspect 6: The method of Aspect 2, wherein the indication of the RMTC configuration includes a periodicity associated with the measurements and expressed in a quantity of fixed frame periods (FFPs).

Aspect 7: The method of Aspect 6, wherein the measurements are performed in a randomly selected FFP of the quantity of FFPs.

Aspect 8: The method of any of Aspects 1 through 7, wherein the report is associated with at least one additional occasion for performing measurements, to determine at least one additional RSSI.

Aspect 9: The method of Aspect 8, wherein the report further indicates the at least one additional RSSI and each additional RSSI is associated with an additional occasion for performing measurement.

Aspect 10: The method of Aspect 8, wherein the report indicates a maximum of the RSSI or the at least one additional RSSI.

Aspect 11: The method of Aspect 8, wherein the report indicates a minimum of the RSSI or the at least one additional RSSI.

Aspect 12: The method of Aspect 8, wherein the report indicates an average of the RSSI and the at least one additional RSSI.

Aspect 13: A method of wireless communication performed by a base station, comprising: transmitting, to a user equipment (UE), an indication of a received signal strength indicator (RSSI) measurement timing configuration (RMTC) associated with an idle period of a frame based equipment (FBE) mode; and receiving, from the UE, a report based at least in part on the indication of the RMTC.

Aspect 14: The method of Aspect 13, wherein the indication of the RMTC configuration includes a symbol-level offset associated with an initial system frame number (SFN).

Aspect 15: The method of Aspect 13, wherein the indication of the RMTC configuration includes a subframe-level offset that is associated with an initial system frame number (SFN) and a symbol-level offset in addition to the subframe-level offset.

Aspect 16: The method of any of Aspects 13 through 15, wherein the indication of the RMTC configuration includes a measurement duration longer than one symbol and shorter than one slot.

Aspect 17: The method of Aspect 13, wherein the indication of the RMTC configuration includes a periodicity expressed in a quantity of fixed frame periods (FFPs).

Aspect 18: The method of Aspect 17, wherein the report is based at least in part on measurements performed in a randomly selected FFP of the quantity of FFPs.

Aspect 19: The method of any of Aspects 13 through 18, wherein the report indicates an RSSI based at least in part on measurements in an occasion during the idle period.

Aspect 20: The method of Aspect 19, wherein the report is associated with at least one additional occasion for performing measurements to determine at least one additional RSSI.

Aspect 21: The method of Aspect 20, wherein the report further indicates the at least one additional RSSI.

Aspect 22: The method of Aspect 20, wherein the report indicates a maximum of the RSSI or the at least one additional RSSI.

Aspect 23: The method of Aspect 20, wherein the report indicates a minimum of the RSSI or the at least one additional RSSI.

Aspect 24: The method of Aspect 20, wherein the report indicates an average of the RSSI and the at least one additional RSSI.

Aspect 25: A method of wireless communication performed by a user equipment (UE), comprising: performing, during an idle period associated with a frame based equipment (FBE) mode, measurements on a sidelink channel; and determining a sidelink received signal strength indicator (SL RSSI) using the measurements.

Aspect 26: The method of Aspect 25, further comprising: determining a channel busy ratio (CBR) based at least in part on the SL RSSI.

Aspect 27: The method of any of Aspects 25 through 26, further comprising: updating a contention window (CW) associated with the sidelink channel based at least in part on the SL RSSI.

Aspect 28: An apparatus for wireless communication at a device, comprising a processor; memory coupled with the processor; and instructions stored in the memory and executable by the processor to cause the apparatus to perform the method of one or more of Aspects 1-12.

Aspect 29: A device for wireless communication, comprising a memory and one or more processors coupled to the memory, the one or more processors configured to perform the method of one or more of Aspects 1-12.

Aspect 30: An apparatus for wireless communication, comprising at least one means for performing the method of one or more of Aspects 1-12.

Aspect 31: A non-transitory computer-readable medium storing code for wireless communication, the code comprising instructions executable by a processor to perform the method of one or more of Aspects 1-12.

Aspect 32: A non-transitory computer-readable medium storing a set of instructions for wireless communication, the set of instructions comprising one or more instructions that, when executed by one or more processors of a device, cause the device to perform the method of one or more of Aspects 1-12.

Aspect 33: An apparatus for wireless communication at a device, comprising a processor; memory coupled with the processor; and instructions stored in the memory and executable by the processor to cause the apparatus to perform the method of one or more of Aspects 13-24.

Aspect 34: A device for wireless communication, comprising a memory and one or more processors coupled to the memory, the one or more processors configured to perform the method of one or more of Aspects 13-24.

Aspect 35: An apparatus for wireless communication, comprising at least one means for performing the method of one or more of Aspects 13-24.

Aspect 36: A non-transitory computer-readable medium storing code for wireless communication, the code comprising instructions executable by a processor to perform the method of one or more of Aspects 13-24.

Aspect 37: A non-transitory computer-readable medium storing a set of instructions for wireless communication, the set of instructions comprising one or more instructions that, when executed by one or more processors of a device, cause the device to perform the method of one or more of Aspects 13-24.

Aspect 38: An apparatus for wireless communication at a device, comprising a processor; memory coupled with the processor; and instructions stored in the memory and executable by the processor to cause the apparatus to perform the method of one or more of Aspects 25-27.

Aspect 39: A device for wireless communication, comprising a memory and one or more processors coupled to the memory, the one or more processors configured to perform the method of one or more of Aspects 25-27.

Aspect 40: An apparatus for wireless communication, comprising at least one means for performing the method of one or more of Aspects 25-27.

Aspect 41: A non-transitory computer-readable medium storing code for wireless communication, the code comprising instructions executable by a processor to perform the method of one or more of Aspects 25-27.

Aspect 42: A non-transitory computer-readable medium storing a set of instructions for wireless communication, the set of instructions comprising one or more instructions that, when executed by one or more processors of a device, cause the device to perform the method of one or more of Aspects 25-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors coupled to the memory, wherein the memory includes instructions executable by the one or more processors to cause the UE to:
perform, in an occasion during an idle period associated with a frame based equipment (FBE) mode, measurements to determine a received signal strength indicator (RSSI); and
transmit, to a base station, a report based at least in part on the RSSI.

2. The apparatus of claim 1, wherein the memory further includes instructions executable by the one or more processors to cause the UE to:
receive, from the base station, an indication of an RSSI measurement timing configuration (RMTC).

3. The apparatus of claim 2, wherein the indication of the RMTC configuration includes a symbol-level offset associated with an initial system frame number (SFN).

4. The apparatus of claim 2, wherein the indication of the RMTC configuration includes a subframe-level offset that is associated with an initial system frame number (SFN) and a symbol-level offset in addition to the subframe-level offset.

5. The apparatus of claim 2, wherein the indication of the RMTC configuration includes a parameter associated with a measurement duration longer than one symbol and shorter than one slot.

6. The apparatus of claim 2, wherein the indication of the RMTC configuration includes a periodicity associated with the measurements and expressed in a quantity of fixed frame periods (FFPs).

7. The apparatus of claim 6, wherein the measurements are performed in a randomly selected FFP of the quantity of FFPs.

8. The apparatus of claim 1, wherein the report is associated with at least one additional occasion for performing measurements, to determine at least one additional RSSI.

9. The apparatus of claim 8, wherein the report further indicates the at least one additional RSSI and each additional RSSI is associated with an additional occasion for performing measurement.

10. The apparatus of claim 8, wherein the report indicates a maximum of the RSSI or the at least one additional RSSI.

11. The apparatus of claim 8, wherein the report indicates a minimum of the RSSI or the at least one additional RSSI.

12. The apparatus of claim 8, wherein the report indicates an average of the RSSI and the at least one additional RSSI.

13. An apparatus for wireless communication at a base station, comprising:
a memory; and
one or more processors coupled to the memory, wherein the memory includes instructions executable by the one or more processors to cause the base station to:
transmit, to a user equipment (UE), an indication of a received signal strength indicator (RSSI) measurement timing configuration (RMTC) associated with an idle period of a frame based equipment (FBE) mode; and
receive, from the UE, a report based at least in part on the indication of the RMTC.

14. The apparatus of claim 13, wherein the indication of the RMTC configuration includes a symbol-level offset associated with an initial system frame number (SFN).

15. The apparatus of claim 13, wherein the indication of the RMTC configuration includes a subframe-level offset that is associated with an initial system frame number (SFN) and a symbol-level offset in addition to the subframe-level offset.

16. The apparatus of claim 13, wherein the indication of the RMTC configuration includes a measurement duration longer than one symbol and shorter than one slot.

17. The apparatus of claim 13, wherein the indication of the RMTC configuration includes a periodicity expressed in a quantity of fixed frame periods (FFPs).

18. The apparatus of claim 17, wherein the report is based at least in part on measurements performed in a randomly selected FFP of the quantity of FFPs.

19. The apparatus of claim 13, wherein the report indicates an RSSI based at least in part on measurements in an occasion during the idle period.

20. The apparatus of claim 19, wherein the report is associated with at least one additional occasion for performing measurements to determine at least one additional RSSI.

21. The apparatus of claim 20, wherein the report further indicates the at least one additional RSSI.

22. The apparatus of claim 20, wherein the report indicates a maximum of the RSSI or the at least one additional RSSI.

23. The apparatus of claim 20, wherein the report indicates a minimum of the RSSI or the at least one additional RSSI.

24. The apparatus of claim 20, wherein the report indicates an average of the RSSI and the at least one additional RSSI.

25. An apparatus for wireless communication at a user equipment (UE), comprising:
a memory; and
one or more processors coupled to the memory, wherein the memory includes instructions executable by the one or more processors to cause the UE to:
perform, during an idle period associated with a frame based equipment (FBE) mode, measurements on a sidelink channel; and
determine a sidelink received signal strength indicator (SL RSSI) using the measurements.

26. The apparatus of claim 25, wherein the memory further includes instructions executable by the one or more processors to cause the UE to:
determine a channel busy ratio (CBR) based at least in part on the SL RSSI.

27. The apparatus of claim 25, wherein the memory further includes instructions executable by the one or more processors to cause the UE to:
update a contention window (CW) associated with the sidelink channel based at least in part on the SL RSSI.

28. A method of wireless communication performed by a user equipment (UE), comprising:
performing, in an occasion during an idle period associated with a frame based equipment (FBE) mode, measurements to determine a received signal strength indicator (RSSI); and
transmitting, to a base station, a report based at least in part on the RSSI.

29. The method of claim 28, further comprising:
receiving, from the base station, an indication of an RSSI measurement timing configuration (RMTC),
wherein the indication of the RMTC configuration includes a symbol-level offset associated with an initial system frame number (SFN).

30. The method of claim 28, further comprising:
receiving, from the base station, an indication of an RSSI measurement timing configuration (RMTC),
wherein the indication of the RMTC configuration includes a subframe-level offset that is associated with an initial system frame number (SFN) and a symbol-level offset in addition to the subframe-level offset.
